(19) United States
(12) Patent Application Publication
(10) Pub. No.: US 2019/0202197 A1
(43) Pub. Date: Jul. 4, 2019

(54) PROCESSING MACHINE SYSTEM AND METHOD FOR OPERATING A PROCESSING MACHINE SYSTEM

(71) Applicant: KOENIG & BAUER AG, Würzburg (DE)

(72) Inventors: Stefan SINGER, Radebeul (DE); Matthias ENGELMANN, Lenz (DE); Mario LINDNER, Cossebaude (DE); Matthias VOGT, Dresden (DE); Frank BROSCH, Radebeul (DE); Matthias FÖRSTER, Coswig (DE)

(73) Assignee: Koenig & Bauer AG, Würzburg (DE)

(21) Appl. No.: 16/325,211

(22) PCT Filed: Mar. 29, 2018
(86) PCT No.: PCT/EP2018/058196

§ 371 Date: Feb. 13, 2019

(30) Foreign Application Priority Data
Mar. 31, 2017 (DE) 10 2017 205 576.6
Mar. 31, 2017 (DE) 10 2017 205 577.4

(51) Int. Cl. B41F 33/00; B41F 33/16; B41F 33/02

(52) U.S. Cl. CPC B41F 33/0009; G06Q 50/28; B41F 33/02; B41F 33/16

(57) ABSTRACT

A processing machine system has at least one mobile control unit. At least one substance-related feature of the processing machine system can be detected by the mobile control unit. Upon detection of the substance-related feature by the mobile control unit, data which is associated with the feature can be made available to a user by the mobile control unit. A method is provided for operating such a processing machine system. The invention provides an alternative processing machine system or an alternative method for operating a processing machine system. The data associated with the feature contains data concerning at least one consumable of the processing machine system.

### CROSS REFERENCE TO RELATED APPLICATIONS

This application is the U.S. National Phase, under 35 U.S.C. § 371, of PCT/EP2018/058196, filed Mar. 29, 2018; published as WO 2018/178291 A1 on Oct. 4, 2018 and claiming priority to DE 10 2017 205 576.6 filed Mar. 31, 2017 and to DE 10 2017 205 577.4 also filed Mar. 31, 2017, the disclosures of which are expressly incorporated herein in their entireties by reference.

### FIELD OF THE INVENTION

The present invention relates to a processing machine system and to a method for operating a processing machine system.

### BACKGROUND OF THE INVENTION

Processes and tasks or control operations to be performed during the production of a product can be calculated and visually displayed. The information is typically displayed visually on a display device of the production machine, e.g. at a control console of a sheet-fed printing press, with the information typically being displayed only on permanently installed display devices.

In sheet processing machines, for example, it is known to use control panels with keys for operation control. The keys can have a defined function. It is also possible for multiple functions to be assigned to individual keys (dual function). Operations can also be controlled via display screens, e.g. using menus. In such cases, the operator must navigate within the interface to the control element in the appropriate screen, which requires familiarity with the screen and multiple keystrokes, among other things.

Frequently, supplementary systems are also installed in machines and systems for the purpose of online data collection. In particular, automatic recording of the consumption of auxiliary materials such as detergents or production additives that are added to the production process manually is not an option. These consumption levels are typically recorded manually or, e.g., with the aid of barcode scanners. Linking the recorded data to the production process (job, meter, time . . . ) is an elaborate process, as typically there is no direct connection to the controller of the production machine. Moreover, recording data about consumable materials, e.g. for sheet-fed printing presses, is an elaborate process because at this time, no integrated solution exists. For most products, data are not recorded at all or are recorded only manually on paper or job paperwork or using barcode scanners.

The processes of a production run are further controlled using job paperwork, e.g. job tickets, pile dockets, etc. The production of products such as folding cartons typically involves machines from a variety of manufacturers (printing, punching, gluing, packaging, stacking . . . ). The machines used are equipped for automation and networking to a greater or lesser degree. Thus, a hardware-based or permanent linkage of all the machines to a production control system, for example, has not yet been universally implemented. Such an interlinking of the machines also has not yet been realized for economic reasons. Data recording stations require space for installation and must be capable of coping with environmental factors such as dirt, moisture, etc. Suitable solutions are therefore complex and costly.

When mobile terminal devices are used for data recording or for controlling machinery in a production process (mobile and stationary applications), the terminal devices are typically equipped with batteries as a power supply. These are generally charged after use by plugging into a charger. It is also possible for additional batteries to be connected to the terminal device via a cable. However, this is ergonomically inconvenient in terms of operation.

From DE 43 06 098 A1 a device for controlling individual functional units of a printing machine is known, in which a portable control device is provided, which is parked at a parking position of a corresponding functional unit and which is divided into a multiplicity of surface areas. Based upon the selected parking position, the surface areas of the portable control device are associated visually with the corresponding functions of the functional unit via a provided coding unit. One drawback of this solution is that only the functions of the corresponding functional unit are displayed visually on the portable control device.

From EP 1 247 656 A1, a system for producing printed products is known, in which the position of a freely movable input device relative to the processing stations is recognized automatically. Using a single input device, the processing stations of one or more machines can be controlled locally in terms of adjustments, corrections, optimization, error acknowledgment, starts and stops. The disadvantage of this solution is that only one machine controller is involved.

DE 102 34 467 A1 discloses a method for the automated control of an industrial system and a process control system for implementing said method, wherein process control signals generated in a mobile control unit are transmitted wirelessly to interfaces and are forwarded from said interfaces to a central control system. The disadvantage of this solution is that only process control signals are taken into account.

From DE 103 39 571 A1, a method and a device for optimizing a job change are known, in which a control computer is used to establish the optimized order of pending operations. This established order is displayed visually to machine operators, and the machine operators are guided through the individual steps by means of one or more display devices attached to the machines being used to process the printing materials. The disadvantage of this solution is that machine operators are required to remain at the control console of the machine, and thus flexibility is restricted. Moreover, only process steps can be calculated and displayed.

From DE 10 2006 052 646 A1, a printing machine having a plurality of operating zones is known, in which the position of a mobile control device is detected and based upon this position, certain functions of the machine processing the printing materials are enabled or disabled. The disadvantage of this solution is that only machine functions are included, and that a cumbersome or imprecise and potentially time-consuming detection of the position of the mobile control device is necessary.

From DE 10 2008 009 177 A1 a printing press control system is known, in which at least one mobile control unit is provided, which can be used to control functionalities of at least one unit of the printing press, dependent upon the current user and/or the current location of use of said mobile control unit. The disadvantage of this solution is that it includes only a machine-specific and/or production status-specific range of functions.

From DE 10 2009 002 251 A1, a printing press with an integrated control system is known, in which the press operates automatically and displays disruptions and/or setting corrections to the operator via displays. The information can also be output via mobile phone or PDA. The disadvantage of this solution is that a fully automated press is extremely expensive and prone to malfunction. Last but not least, there is the problem of the feasibility of a fully automated press.

DE 10 2012 217 364 A1 discloses a method and a device for handling bundles of printing substrate in a printing substrate supply system of a print shop that comprises a printing press, in which, via a control panel for an intake point and a unit, the status and/or the current location of bundles of printing substrate are updated in a database system. The control panels are not suitable for mobile control operations or for rapid monitoring of the flow of material or for material tracking.

From CH 706 471 A1, a mobile unit for allocating production system-specific functions is known, with the production system-specific functions of the mobile unit being allocated on the basis of the sector, which is determined from the spatial position of the mobile unit. The disadvantage of this solution is that only production system-specific functions are allocated.

Monitoring of a machine that generates vibrations is known from EP 2 275 704 A1, wherein an output of information can also involve the transmission of at least one SMS on at least one cell phone.

### SUMMARY OF THE INVENTION

The object of the present invention is to provide an alternative processing machine system or an alternative method for operating a processing machine system.

The object of the present invention is attained, according to the invention, by the provision of a processing machine system having at least one mobile control unit. At least one material-specific feature of the processing machine system can be detected by the mobile control unit. Upon detection of the material-specific feature by the mobile control unit, data associated with the feature one of can be or is supplied to an operator by the mobile control unit. The data associated with the material-specific feature contains data relating to at least one consumable material of the processing machine system. A method for operating a processing machine system having at least one mobile control unit includes detecting the at least one material-specific feature of the processing machine by the mobile control unit. Upon detecting of the material-specific feature by the mobile control unit, data associated with the material-specific feature is supplied to an operator by the mobile control unit. The data which is associated with material-specific feature contains data relating to at least one consumable material of the processing machine system. A mobile control unit of such a processing machine or of a post-press processing machine of a processing machine system, is used for the purpose of supplying data relating to at least one consumable material of the processing machine system following a specific recognition of a detected material-specific feature, in particular a tag or an NFC tag.

The invention has the advantage of providing an alternative processing machine system and an alternative method for operating a processing machine system.

A processing machine system having at least one mobile control unit can be provided, for example, wherein the mobile control unit is and/or can be used to make machine-relevant, process-relevant, and/or consumable material-relevant data, in particular printing substrate-relevant data, available to an operator. Process-relevant data may include data related to settings, corrections, optimization, error acknowledgment and/or the starting and stopping of processing stations of one or more machines. These data may also relate to the regulation, control, diagnosis, and/or visualization of individual process steps or process modes, or general functions, such as information regarding machine status or production status. The control of units of the production system, a display of status data for units of the production system, a display of service instructions for units of the production system, a display of repair instructions for units of the production system and/or a display of routing information for locating units of the production system may also be included.

In addition, data relating to control operations to be carried out on a processing machine and/or a post-press processing machine can be provided to the operator by the mobile control unit. The mobile control unit communicates wirelessly, in particular. The control unit preferably includes a visual display or presentation device for presenting data visually. More particularly, the control unit is equipped with a touch-sensitive display via which information relating, in particular, to data can be entered, for example. The mobile control unit may further be a control unit of a processing machine and/or a post-press processing machine. The mobile control unit is particularly preferably embodied as a smartphone. Control operations may be, in particular, steps that can be calculated or specified via a control system or a data management system. As a data management system or data processing system, a separate computing system is provided, for example, with the data management system preferably being configured as a higher-level and/or machine-independent system. A machine-independent data management system enables, in particular, the logistical management of consumable materials, for example, in particular of printing substrates that are or will be processed, even in multiple processing machines and/or post-press processing machines. Assistant technicians, in particular, can use this type of machine-independent data management system with a processing machine and/or post press processing machine, without constant logging-on and logging-off processes.

The mobile control unit can be used, for example, to transmit and/or display to the operator data relating, in particular, to the control operations that are to be carried out next. In particular, the data relating to control operations to be carried out may contain and/or represent data relating to individual steps. For example, individual steps of the control operations to be carried out can also preferably be made available or transmitted and/or displayed dependent upon confirmation by the operator. Preferably, the control unit guides the operator through control operations to be carried out and/or individual steps, in particular of control operations. The data relating to control operations to be carried out preferably contain data relating to the sequence and/or the locations of control operations. The control operations can also be made available via the mobile control unit in a sequence which is optimized according to specified or preselectable criteria.

The data supplied by the control unit contain, for example, information and/or instructions relating to a material change or consumable material change or a job change in a processing machine, in particular a sheet processing machine, for example a sheet-fed printing press, preferably a sheet-fed offset rotary printing press in a unit and inline configuration, and/or a post-press processing machine. Preferably, the data supplied by the mobile control unit may contain data relating to at least one consumable material for a processing machine and/or a post-press processing machine. In particular, it is provided for data relating to the quantities of consumable material that remain in a processing machine and/or post-press processing machine and/or in a materials warehousing system to be supplied. The control unit can communicate with a data management system and/or with at least one machine controller, for example. The operator can also use the control unit to transmit control operations that have been carried out to a data management system and/or a machine controller. In particular, consumable materials that have been consumed or used up can be transmitted to the data management system, enabling an updated materials inventory to be recorded by the data management system or enabling data relating to the stored materials inventory to be updated. Data for a materials warehousing system can also be stored in the data management system or transmitted to the control unit, which can then make these data available to the operator.

In this way, information relating to control operations and tasks to be completed can be provided easily and quickly, in particular, to the employees and/or operators involved in the production process. This results in a decrease in organizational downtime, enabling an increase in productivity to be achieved. It is possible, in particular, to transmit and/or display the tasks that are required for a production run or for a job change (operations, tasks, manual or automatic processes, auxiliary operations) on at least one mobile control and display device, e.g. smartphone, tablet, or data glasses. However, a plurality of control units that are preferably also capable of communicating with one another may also be integrated into the processing machine system or used with the processing machine and/or the post-press processing machine.

A processing machine system, in particular having a production system or having at least one processing machine and/or at least one post-press processing machine, for example as described above, has at least one mobile control unit, for example a tablet or preferably a smartphone. The at least one mobile control unit may be a control unit for one or more processing machines and/or one or more post-press processing machines and/or for materials, in particular consumable materials. It is also possible for a plurality of such control units that cover different control functions to be provided in the processing machine system. Each of the one or more mobile control units is equipped with a rechargeable energy storage device, in particular a rechargeable battery, or battery for short. Accordingly, the processing machine system, in particular one, multiple, or all of the processing machines and/or one, multiple, or all of the post-press processing machines has/have at least one charging point for the energy storage device, in particular the battery, of the at least one mobile control unit. In particular, the charging point is associated with one charging device or one charging station for the at least one mobile control unit. Preferably, the charging point may be a control station or a main control station of a processing machine or post-press processing machine, and the mobile control unit can be charged automatically during use by means of the charging device integrated into the charging site or control station, without any additional action.

Particularly preferably, the charging point can be configured for wireless and/or inductive charging of the battery of the one, multiple, or all of the mobile control units of the processing machine system. The charging point may comprise a securing device for a mobile control unit, for example, so that the mobile control unit can be assigned to the charging point permanently, for example, in a force-fitting and/or form-fitting attachment. For example, the charging device can be integrated or permanently installed, e.g. below or in the control station, in which the mobile device (e.g. smartphone or tablet) is attached or stored temporarily for the purpose of operation. For example, the charging point or the charging device may be integrated into a shelf area for the mobile control unit, which shelf area is used, in particular, for logistical and/or storage purposes. More particularly, the charging point may be a shelf area for the mobile control unit at a central control station or a control console of a processing machine or post-press processing machine. In that case, the charging station is integrated, hidden for example, in the shelf area, e.g. at the central control station, in particular the control console.

When a particular mobile control unit, for example a tablet or preferably a smartphone, is associated with a charging point, the energy storage device, in particular the battery, of the at least one mobile control unit is charged through the charging point of the processing machine system, the processing machine, or the post-press processing machine. More particularly, the mobile control unit is placed at the control station of the processing machine, the post-press processing machine, or a control console and is preferably charged there automatically or wirelessly via the charging point. Particularly preferably, the charging process takes place automatically without any additional action, or the charging process is started automatically. In this way, a simple method for charging and/or recharging the mobile control units is achieved by equipping the control stations with contact-free inductive charging devices, e.g. Qi (the standard of the Wireless Power Consortium for wireless energy transmission by means of electromagnetic induction over short distances). Multiple mobile control units can be charged in succession, i.e. one after the other, at one charging point of the processing machine system, the processing machine, or the post-press processing machine, or can be charged in parallel, i.e. at least partially simultaneously, at multiple charging points in the processing machine system, a processing machine, and/or a post-press processing machine.

A charging routine that controls the charging process on the basis of parameters may also be stored. For example, the charging process may be implemented dependent upon the charging status and/or dependent upon the anticipated holding time or storage time of the mobile control unit. The anticipated holding time of the mobile control unit may be determined, for example, by the scope of control operations activated by the control unit, by the specific location of the shelf area and/or by manual input, for example. A charging routine of this type enables battery-saving charging processes, in particular, to be carried out. Such a charging routine can be stored, for example, in a control system that cooperates with the charging point, for example the machine controller. This enables the charging status of the mobile control units to be known to the control system for other purposes as well.

With one or more such charging points in the processing machine system, for example a press room, one or more mobile control units of the processing machine system can be charged. Advantageously, plugging into a power supply can be dispensed with, thereby eliminating wear and tear on a plug or socket of the mobile control unit. Handling is also simplified. As a result, in particular, the availability and the service life of mobile devices and control units in the processing machine system are increased, wear and tear is reduced, and/or the handling of mobile control units is simplified.

Particularly preferably, a or the processing machine system involves an optimization of the processes for producing a product in an operation involving multiple machines, preferably at least one printing press, in particular a sheet-fed printing press, and at least one post-press processing machine, e.g. a punch, a gluing machine, etc. In particular, a visual display of the tasks to be performed is provided on a mobile control unit, which is connected to a production machine and/or a production control system (management information system (MIS), industry software, etc.). Preferably, supplemental information is displayed, e.g. when a liquid is being replenished, how long the current level will suffice or when the liquid will need to be replenished again, and/or the amount of liquid remaining in stock in the materials warehousing system. For example, it may be indicated that the last canister from a local warehouse has been used.

The processing machine system has at least one or preferably a plurality of material-specific features, for example. Material-specific means that the feature is embodied in the processing machine system. A feature may be an optical and/or an electronically supported feature which is located in the processing machine system. The location of the material-specific feature may be location-specific, machine-specific and/or consumable material-specific, for example. The material-specific feature can be a surface or an object on a surface. Preferably, the material-specific feature can be the surface of a consumable material, a machine, or a post-press processing machine or an object on the surface of a consumable material, a machine, or a post-press processing machine. In particular, a material-specific feature has or contains a code. In particular, the material-specific feature contains a unique identification code. For example, the material-specific feature may include or contain patterns, letters, and/or numerals. For example, the feature may contain an identification code which is preferably uniquely associated with a location or a site and/or a consumable material. In the preferred embodiment, the feature is a tag, in particular an RFID tag or particularly preferably an NFC tag. The material-specific feature can be detected, in particular, by the mobile control unit and recognized by identification. The mobile control unit may have an NFC interface, for example, for electromagnetically addressing a respective NFC tag. Once the specific NFC tag has been identified, data, which are assigned via the specifically recognized NFC tag or are stored directly on the specific NFC tag, can be displayed and/or modified via the mobile control unit.

To enable confirmation of a control operation or a task or an individual step, a material-specific feature in particular, preferably a tag, in particular an RFID tag or an NFC tag, is attached, e.g. at the consumption site, such that it is ergonomically easily accessible and can be used to confirm the task to be performed. The operator can then confirm the task only if he has moved to the location of the control operation or task. Particularly advantageously, the control operations and tasks or processes are reported to a control center and/or a higher-level system, e.g. a data management system, and/or are stored for the purpose of evaluation. In particular, it is provided that the tasks displayed on the mobile control unit, e.g. on a machine-specific basis, are adjusted on the control unit or in the higher-level system. Differentiated input options may be provided, for example, for a machine operator or an assistant technician, or even for specific operators and/or assistant technicians. Particularly preferably, the mobile control unit is connected wirelessly via a data link to a machine, for example for controlling said machine. Alternatively or additionally, however, a wireless data link to a higher-level computer, e.g. a data management system, may also be provided. Data relating to the product in question and/or inventory data (current inventory, minimum inventory) can be displayed on the mobile control unit, for example. In particular, the next time the product in question will be processed and/or will require action, such as replenishing, for example, can be displayed. Remaining quantities and/or ranges can also be displayed (e.g., how much of a special ink, for example, will be required to complete the operation and/or job).

This advantageously enables the production processes in the processing machine system to be optimized, in particular in terms of “lean production”. In addition to increasing productivity, a decrease in or avoidance of downtime can be achieved. Furthermore, the security of information belonging to persons involved is ensured by the respective mobile control unit, for example if the person involved is constantly in possession of the control unit, in particular a smartphone.

A processing machine system, for example as described above, may include one or more processing machines and/or one or more post-press processing machines. A processing machine in this case can be a sheet processing machine or a printing press. A sheet processing machine can be a sheet-fed printing press, for example, specifically a sheet-fed offset rotary printing press, preferably in a unit-based and inline configuration. However, a processing machine may also operate by letterpress or intaglio printing or by a non-impact process and/or may be used to process web-type printing substrates. A post-press processing machine may be, for example, a punching machine, for example a rotary or flatbed punch, a folding, collating, gluing, or folding carton gluing machine, or the like. The processing machine system may contain one or more similar or different types of processing machines and/or one or more similar or different types of post-press processing machines.

In particular, the processing machine system includes a data management system, which is preferably linked to one or more processing machines and/or to one or more post-press processing machines. Preferably, the data management system may be linked to some or to all the machines in the processing machine system. This link may be produced via electrical wiring, for example, or wirelessly. The data management system may also be linked to other machines or units outside of the processing machine system. Preferably, at least one materials warehouse is also integrated into the processing machine system, and more particularly, the data management system is connected to the materials warehouse. The data management system may be in the form of an independent computer unit or may be provided in an existing control system associated with a machine, for example. A data management system may also be composed of multiple subunits. The data management system may be linked to a higher-level control system, for example, or may be integrated into a higher-level control system and/or may cooperate with a process control and/or planning system. However, the data management system may also be integrated, for example, into a control center of a machine or into a unit or into a control system, for example a quality control system.

The processing machine system includes at least one mobile control unit, which may be embodied, for example, as a portable control unit that has a display device or a touchscreen. Using the display device or the touchscreen, data relating to the processing machine system, in particular the data management system, can be displayed visually. In addition to the display device, the control unit may have function keys. Functions of the processing machine system can be initiated and/or controlled and/or executed using a touchscreen or the function keys. More particularly, data of the data management system can be edited and/or processed, or functions can be initiated. For example, data of the data management system can be displayed and/or modified, or data in or for the data management system can be entered. The control unit may be configured, for example, as a portable computer or as a tablet or notebook or mobile telephone. Preferably, the mobile control unit is configured as a smartphone. Particularly preferably, the processing machine system includes multiple mobile control units, all of which are embodied, in particular, as smartphones. The mobile control unit preferably forms a single physical unit but may also include separate functional units.

Use of the at least one mobile control unit of the processing machine system may be user-independent or user-specific. A user-independent control unit can be used only intermittently by one operator, for example, by that operator logging on, and then when a different operator subsequently logs on, that operator is able to use the same control unit. Use of a control unit may also be machine-specific, for example. In the case of a user-independent control unit, various control functions may be enabled or disabled. The enabling of functions may also be parameterized and/or modified. For example, the enabling of functions may be linked to the specific log-on of an operator. Alternatively or additionally, however, one or more user-specific control units may be used. In that case, the control units can be at least temporarily assigned to or associated with an operator, who can then use the control unit in which the enabled functions are stored for the duration of the assignment or allocation. Each authorized operator and/or auxiliary staff member can be equipped with a mobile control unit, in particular a smartphone, for example. Data related to this may be stored in the respective control unit, for example, and/or in the data management system.

The at least one mobile control unit of the processing machine system can be used to manipulate data relating to consumable materials in the processing machine system. For example, data relating to the consumable material in the data management system can, in particular, be displayed, modified, entered, and/or transmitted. If multiple control units are provided, parallel access to data in the data management system is also possible. The data relating to the consumable material used in one or more, and preferably all of the machines and/or post-press processing machines and/or held in one or more materials warehouses are preferably managed centrally. Data may also be managed on a group basis and/or a user-specific and/or machine-specific basis. The data management system can communicate, for example, with other systems, for example with external systems. Such communication may involve transmitting data and/or exchanging data with a linked unit. For example, a link may be established with a manufacturer to enable automatic resupply deliveries of consumable materials, for example.

Examples of consumable materials may include packages of material or substances processed and/or to be processed in a processing machine and/or a post-press processing machine. In particular, quantities, parameters, features, and/or additional information regarding individual or stacked sheets as consumable materials for a sheet processing machine or regarding sheet-type or web-type printing substrates as consumable materials for a printing press can be stored in the data management system. More particularly, however, materials that are consumed by a processing machine and/or a post-press processing machine during its operation, which are held in reserve in a materials warehouse, for example, may also be regarded as consumable material. In a sheet processing machine, in particular a sheet-fed printing press, the following may be understood as consumable materials, for example: printing plates, ink, ink cans, dampening medium additives, blankets, hot stamping foil, IPA (isopropyl alcohol), cold foil, adhesives, coatings, doctor blade lips, cleaning agents, process inks, special inks, underpacking foil, detergents, blanket cleaners, etc. In addition, data relating to associated consumable materials, in particular materials that require changing on a regular or as-needed basis, for example necessary rollers, in particular anilox rollers or the like, can also be stored in the data management system. Data relating to maintenance operations and/or the service life of consumable materials, in particular materials that require replacement, can also be stored. For example, detailed data regarding replacement and changeover procedures may be stored. More particularly, data regarding completed and/or anticipated maintenance operations, such as roller changes, may be stored.

The data stored in the data management system may be filed and/or processed linked to other data, for example. Preferably, it is possible to link data relating to a consumable material to data relating to consumed and/or in-stock quantities. Data relating to a consumable material can also be stored on a unit-specific, a machine-specific, and/or a processing system-specific basis, or even on a job-specific basis. Data relating to a consumable material can also be transmitted, in particular dependent upon the circumstances, to other control systems within and/or outside of the processing machine system. For this purpose, the data management system may be linked, inter alia, to individual units, to one or more machines and/or post-press processing machines and/or control centers, or even to prepress systems or other post-press processing systems.

The data relating to a consumable material, in particular consumable substances and/or printing substrates, may also contain additional information. For example, an indication of whether the consumable materials are partially removable or whether or not a partial removal is possible may be stored. Data relating to the consumable material can also be stored in the data management system. In particular, how and/or where the data can be or have been displayed, modified, and/or entered can be stored. In that case, an input of the data by means of a code, such as a data matrix code, a manual input, a transfer from other systems, an input via interfaces, etc. may be enabled or allowed or specified, for example. A plausibility check and/or an authorization check can also be performed.

A processing machine system, or the processing machine system, contains, in particular, a mobile control unit, via which data relating to at least one consumable material can be supplied, more particularly can be visually displayed or presented or visualized, to a computing unit or data management system. In general, the data can be supplied via the mobile control unit visually, acoustically, and/or mechanically, for example via a vibration alarm. This type of data may be displayed by the control unit, for example, when information regarding a consumable material is delivered to the data management system via the control unit, or when a material-specific feature is recognized by the control unit and information about said feature is transmitted. Data relating to location-specific consumable materials can also be displayed, for example by entering information about a consumable material into the control unit, or with a sensory detection by the control unit of a material-specific feature, in particular a tag. In a further refinement, the location of the mobile control unit can be determined based upon a detection by the control unit of a material-specific feature, in particular a tag, associated with that location. The location of the control unit associated with the consumable material is preferably detected by means of Near Field Communication (NFC). Particular preferably, an NFC tag is applied at a location in the processing machine system that relates to or contains a consumable material, for example directly on a consumable material, a processing machine, and/or a post-press processing machine. Alternatively, the consumable material-relevant location may be detected by means of Radio Frequency Identification (RFID) using RFID tags. Particularly advantageously, the consumable material-relevant location can be determined with minimal effort and very quickly upon recognition of the detected material-specific feature. Direct location detection or positioning by means of Global Positioning System (GPS), Global System for Mobile Communications (GSM), Universal Mobile Telecommunications System (UMTS), Bluetooth and/or a Wireless Local Area Network (WLAN) is not necessary.

Preferably, a tag is assigned to a location in the processing machine system such that the tag can be read out by the mobile control unit, for example by means of Near Field Communication (NFC). Near Field Communication (NFC) is, in particular, an international transmission standard based on RFID technology for the contactless exchange of data over short distances of a few centimeters by electromagnetic induction, in which loosely coupled coils are used. With NFC, a data transmission rate of up to 424 kbit/s, for example, can be achieved. Alternative data transmission options can also be used. In general, the tag may be part of the data management system or may contain data, in particular relating to the consumable material. Data relating to a consumable material, in particular, can thereby generally be associated with the tag, the control unit, and/or the data management system. Preferably, however, a code or an identification code or identification feature, for example a pattern and/or a combination of letters and/or numerals, or even one or more pieces of connection information or links, are stored by the tag. This information can be detected or read out or identified by the mobile control unit, in particular using the NFC technology. Preferably, when the mobile control unit receives this information, the detected material-specific feature, in particular the tag, is identified and recognized or the connection information or links are activated or implemented.

The mobile control unit, optionally in conjunction with the data management system, is capable of identifying the data relating to consumable material and/or a control operation, which may also be associated, for example, with a position or a location. The data management system preferably supplies the data relating to one or more consumable materials and/or the control operation to the mobile control unit at the relevant location. This allows the operator to access the data relating to the associated consumable material or the control operation via the mobile control unit at the specified or specifiable location. More particularly, the data can be displayed by the mobile control unit. For example, the nature of the consumable material, the amount of material available, the amount provided based on the job, etc. are displayed to the operator via the mobile control unit. The data may be displayed separately or together, directly or upon actuation of a control element of the control unit. In particular, the inventory in a materials warehouse, for example, for the consumable material which is required at the site can be displayed.

When a consumable material is replaced or replenished or changed, for example, the data relating to the consumable material in question can be modified via the mobile control unit. In such cases, the data relating to the consumable material in the data management system can be influenced, for example, by appropriate control operations or input into the mobile control unit. For example, the quantity of the consumable material, in particular the quantity of the consumable substances or printing substrates, that is used may be entered, and the data in the data management system thereby updated. If refill quantities are specified, a simple confirmation via the mobile control unit, for example by actuation of a control element or by recognition of a material-specific feature, in particular the tag, may be sufficient. The data management system can use the input data to manage a materials warehouse, for example. The data may be updated and/or verified appropriately. Comparisons with other systems may also be carried out, an inspection system may be incorporated, and/or limits may be monitored. For example, upon communication of the use of a particular consumable material and/or a quantity of consumable material, a decrease in the inventory of that material may be qualitatively or quantitatively determined. The data relating to the consumable material in the data management system can be updated or overwritten. It is also possible for a log entry to be made. For example, regarding the use of consumable material, who, when, where, how, how much, at what time, for what purpose, for which job, etc. may be recorded. The consumable material removed can also be analyzed, in particular on a machine-specific, an order-specific and/or a job-specific basis.

The mobile control unit can detect a material-specific feature, for example, more particularly it can recognize a code or the identification of a tag and can then use this to modify the scope of functions of the mobile control unit required at the location in question, if necessary factoring in any functions that are enabled or disabled on a user-specific basis. In this way, the display options and/or the input options of the mobile control unit can be influenced. For instance, the functions that can be selected on the mobile control unit can be limited, for example, to the specific consumable material and/or can be adapted to the identified location of the control unit. It is also possible for the scope of functions to be adapted to a processing machine or post-press processing machine that is equipped, for example, with a material-specific feature, in particular an NFC tag.

Furthermore, the mobile control unit can also be connected to a machine, for example a sheet processing machine, for example via a control system, in particular a control center, or via the machine controller. This enables machine-relevant, process-relevant, and/or consumable material-relevant data to be displayed and/or enables units or the machine to be controlled by means of the mobile control unit. Secondarily, the position of the mobile control unit can generally likewise be determined for the purpose of process control, for example as described above. Particularly preferably, the location in question can likewise be determined, for example using NFC technology, via tags, in particular NFC tags, attached to the machine, and the mobile control unit can thereby be integrated into the machine controller. In this process, the mobile control unit can communicate wirelessly both with the data management system and with a machine controller or some other controller. The machine controller can also cooperate with or be integrated into the data management system. A further function of the mobile control unit may be, for example, to display, in particular, machine-specific maintenance intervals, operating instructions, repair instructions, and/or order forms for materials, consumable materials, and/or processing materials. Alternatively or additionally, it may be possible to display and/or select a replacement parts catalog via the mobile control unit.

For machine control and/or to display information, for example, simple, event-driven navigation within complex menu structures can be carried out with the aid of a mobile control unit. When, for example as part of a job change in a sheet-fed printing press, the format will be changed or adjusted, an assistant technician will need to move a new pile of printing substrate into the working position at the feed unit. This can be displayed to the operator in an event-driven manner via the mobile control unit, for example in a submenu, in which the progress of the job change can also be visualized. And preferably, this information is displayed only if something actually needs to be done for the machine or the pile. Thus, this is a “smart” display which is helpful during the setup process. Additional help menus and detailed explanations can be made available to the operator via the mobile control unit. Preferably, mobile communication devices, such as a tablet or a smartphone, are used here, which communicate wirelessly via a network, e.g. a web server, with the controller of a machine, a system, and/or the data management system or a production control system, and in a further refinement, navigation in the control menu is influenced in a controlled manner by messages (data), which are sent to the mobile control unit.

In the processing machine system, a printing press or a punch having a controller and at least one stationary control device and at least one mobile control unit can also be provided, for example, which has more than one control menu or display menu, in which case the mobile control unit is linked via a data interface to the controller of the printing press (PLC, control center, control device, etc.) and exchanges data between the mobile control unit and the controller. Messages and/or events can be sent to the mobile control unit, with the target menu that is linked to the message or the event advantageously also being transmittable within the message. Additionally, a list in which a link between the message and a target menu to be displayed is stored can be stored in the mobile control unit. In particular, the target menu can be called up automatically on the mobile control unit. This calling up of the target menu associated with a message advantageously saves on at least one keystroke, thereby simplifying the operation. A target menu can be selected or activated, for example, via connection information, for example a link. Such a link can be transmitted or selected in connection with a tag, or a link stored in the tag can be transmitted directly to or executed by the mobile control unit upon recognition of the tag by the mobile control unit.

It is further possible, for example, to use simple data capturing devices which can be linked via simple and cost-effective means to a controller of a production machine. This enables the reliable detection of production accessories, in particular. Here, the use of at least one mobile control unit, in particular a mobile communication device, e.g. a tablet or a smartphone, which communicates via a network, e.g. a web server, with the controller of the machine, system, and/or data management system, can be provided. The mobile control unit can also communicate in particular wirelessly, e.g. with a machine controller. The mobile control unit can be used to identify consumable materials, for example by means of a sensor system, in particular a camera, e.g. by scanning applied codes, etc. A sensor system of the mobile control unit is therefore used to capture data relating to consumable materials used in the processing machine system.

A camera of the mobile control unit, for example, can also be used to scan codes, for example for a consumable material or printing substrate and/or a material-specific feature, in which case the codes can also be decrypted by the mobile control unit. Alternatively, the codes can be transmitted by the mobile control unit to another computer, for example to a control center or a data management system, for decryption. In particular, the link to the machine or to a unit of a machine and/or to job data can be established automatically by means of position detection, for example via a link to the material-specific feature, preferably a tag or an NFC tag. The position, if known, can also be used to open up an associated control menu, in particular automatically, and/or to activate provided or required sensors, e.g. a camera, in particular for scanning codes, for example on an ink can. This advantageously ensures a simplification of the operation. A reliable association with the machine or with the unit by the material-specific feature, in particular a tag or NFC tag, is likewise possible. In that case, the position is particularly preferably determined using the specified location of the recognized material-specific feature, in particular the tag or NFC tag, which is stored, for example, in the data management system. Furthermore, the detection devices are advantageously cost-effective.

Furthermore, production processes can be optimized and/or downtime resulting, e.g. from a shortage of consumable materials can be prevented, for example. This can be achieved, in particular, by displaying additional information to the operator, for example during the replenishing of consumable substances or consumable materials. With the mobile control unit combined with mark detection, for example of a tag or NFC tag, data relating to consumable materials can be easily captured and/or updated. Additional information regarding consumable materials, e.g. how much more ink will be required to complete a job, enables the quantity supplied to be reconciled early on with the quantity actually being consumed during production. Periods of downtime resulting from a shortage of consumable materials can thus be minimized or prevented. The use of mobile control units, e.g. smartphones or tablets, enables data to be detected by means of NFC technology near the location where the consumable material is used. In particular, NFC tags are attached in the area near consumption points and/or in the area of a materials warehouse in a production plant where printed products are produced. In particular, each NFC tag is assigned a location and/or preferably a function. For example, an ink can in the first printing couple of a sheet-fed printing press, for example, may be detected by the number one.

The mobile control unit is connected to the control system of a processing machine and/or to a planning system of a print shop via a wireless data link, for example. Following the detection of a material-specific feature, in particular the tag or NFC tag, and the recognition of the specific function or the relevant location, additional information, e.g. job information, the anticipated time remaining and/or the anticipated quantity of consumable material that will be required to complete the job and/or the operation, can be displayed on the mobile control unit. The consumable material may comprise, for example: printing substrates or piles of printing substrate to be printed and/or already partially or fully printed, or ink, powder, detergent, etc. in a sheet-fed printing press and/or adhesive in a folding carton gluing machine. In particular, following the identification of the material-specific feature, in particular the tag or NFC tag, the supplementary data from the machine controller, the production planning system or the data management system that are associated with the “function” of said feature are displayed on the mobile control unit. The recorded consumption data may be supplemented with the data for the print job (job number, sheet counter, operator, etc.). Advantageously, a simplification of control and/or an increase in productivity can thus be achieved in particular by a prevention of downtime.

A processing machine, in particular a sheet-fed printing press, for example, is provided in the processing machine system. At least one and preferably multiple mobile control units are assigned to this processing machine, in particular this sheet-fed printing press. For changing the function of the mobile control units, in particular for changing control menus, material-specific features, in particular tags or NFC tags or other codes, are attached to the processing machine, in particular the sheet-fed printing press. With said features, the user interface of the mobile control unit can preferably be changed based upon the information obtained from the feature, in particular the tag, code, etc. For example, a camera of the control unit for capturing data, for example for scanning codes such as barcodes, can be switched on or used. The codes can be decrypted by the mobile control unit, or data, for example images of the codes, can be sent to a computer, for example the data management system, for decryption. The mobile control unit uses wireless communication for this purpose. As a further refinement, the mobile control unit can communicate with the machine controller of the sheet-fed printing press for the purpose of control and/or display.

Particularly preferably, data from NFC tags are read by the mobile control unit by means of an NFC interface of the mobile control unit. In this context, it is preferable to use mobile control units, in particular communication devices (e.g., tablets or smartphones), that preferably communicate wirelessly via a network, e.g. a web server, with the controller of a machine, a system, and/or the data management system. Material-specific features, in particular tags (e.g., RFID, NFC), barcodes, data matrix codes, local network connections, etc., are preferably attached based upon positions (locations, functions) that are ergonomically or logically useful for the operator, in particular on processing machines, post-press processing machines and/or consumable materials.

The recognition of a specific tag, if applicable at a specific position, triggers the display of the necessary control menu (stored logically in the tag, optionally with the data management system) to be displayed, in particular on the mobile control unit (preferably without actuation of a control element). This means, in particular, that the tag, which is attached to or in the vicinity of the machine, causes a control menu linked to it by logic to be displayed without prompting by a manual operation. Preferably, it is necessary only for the control unit to approach the tag, or for a code to be scanned. Thus, a simple navigation operation within complex menu structures is carried out by means of simple mobile control units for the purpose of obtaining information or for machine control, in which case a mobile control unit can be linked by simple and cost-effective means to the controller of the production machine. This advantageously results in a simplification of the control process and faster product training. By reducing the number of permanently installed control elements and/or control units, a reduction in production costs can be achieved. The mobile control units are cost-effective.

In a/the processing machine system, a tag-based capturing of data, in particular an NFC tag-based capturing of data, by means of one or more mobile control units preferably occurs. For this purpose, tags or NFC tags are attached, for example, to some or all of the machines in the production system, in particular to all the processing machines and post-press processing machines of the processing machine system. By means of a specific tag or NFC tag, the location or the machine can be stored, for example, or can be assigned via a data processing system, for example the data management system, in particular a production control system (PCS) or a management information system (MIS).

Functions in the mobile control unit, in particular in a smartphone, are preferably controlled by means of near field communication (NFC) between the NFC tag and the NFC interface of the mobile control unit. For example, a program for capturing data can be started automatically on the mobile control unit, the camera can be activated for scanning a code on a pile docket, for example, and/or printing, for example, of a processing paper (e.g. a pile docket) can be requested.

This enables data from one location or one machine, e.g. a punch, to be linked, in particular via an NFC tag, to the data of a production lot or a printed substrate or sheet pile. The data of the production lot or the printed pile can be identified, for example, via a machine-readable code, e.g. a barcode, on a processing paper (e.g. on a pile docket) or an NFC tag associated with the lot or pile. This linkage or combination or comparison of the data can be carried out on the mobile control unit and/or in a data processing system, e.g. the data management system, in particular the PCS or the MIS.

Particularly preferably, in conjunction with a production control system, data capturing is accomplished with the aid of the at least one mobile control unit, with at least one application or one program preferably being controlled on the mobile control unit by means of an NFC tag. In the processing machine system, NFC tags are assigned for this purpose to at least one processing machine, for example one printing press or one sheet processing machine, and to one additional machine. The additional machine can likewise be a printing press or a sheet processing machine, or a post-press processing machine such as a punching machine, a gluing machine, a packaging machine, or a stacking machine, for example.

Each of the NFC tags attached to the processing machine and to the additional machine contains the preferably unique identification codes and can be recognized by identification following detection by a mobile control unit, or by a particular mobile control unit, in particular by a smartphone, or by a particular smartphone, preferably simply by the mobile control unit moving closer to the respective NFC tag, in particular as described elsewhere. For detecting such an NFC tag, a respective mobile control unit has an NFC interface. Furthermore, the one or more mobile control units is/are wirelessly linked to the data management system, in particular the production control system (PCS), and/or to one or more machine controllers. A mobile control unit can thus be used in particular to display data from a control system, such as the data management system or the PCS, or to transfer data to the control system.

The mobile control unit can also be used, for example, to deduce location data and/or machine names or machine designators from an identified NFC tag. These location data or machine names can be assigned via the respective NFC tag. For example, the machine name may be stored directly on the NFC tag or may be assignable via an ID (identification code). Preferably, therefore, the mobile control unit can be used to combine location data or machine names or additional information with data relating to production lots. Material supply and material transfer are supported, in particular, by the associated data processing. Particularly preferably, for the purpose of data capturing, an attached NFC tag on the processing machine or the additional machine is detected, thereby preferably automatically launching or controlling an application or a program of the mobile control unit. More particularly, applications (apps) installed on the mobile control unit can preferably be launched or controlled simply by the mobile control unit moving closer to the NFC tag. A camera for scanning is particularly preferably activated thereby, or the location data or machine data or additional information or one or more links of an NFC tag are used in the application, for example, for data capturing.

A method, in particular, for simple and/or cost-effective data capturing in a production operation is thus provided, for example for the purpose of material tracking. This advantageously enables production processes to be optimized, in particular in terms of “lean production”, cost-effective and easy data capturing, independence from environmental influences, and/or the elimination of stationary data capturing stations. Especially advantageously, simply addressing a particular NFC tag electromagnetically via the NFC interface of the mobile control unit enables data to be supplied by the specific NFC tag to the mobile control unit and/or enables one or more pieces of connection information, such as links, to be supplied to said mobile control unit, said data and/or information being assigned via the specific NFC tag or stored on the NFC tag. The data supplied to the operator by means of the mobile control unit via the data management system and/or a production control system are preferably used by the processing machine system for tracking printing substrates and/or for tracking or updating data relating to specific jobs.

A mobile control unit can also be used for the sensory detection of printing-relevant parameters of materials, for example printing substrates or consumable materials, for the presetting of machine parameters, in particular as part of a preferably fully automatic job change. In addition or as an alternative to fully automatic job changes, the same mobile control unit can be used in the receiving area for goods or in the warehouse management system.

On a processing machine, for example for a job change on a printing press, in addition to receiving print job data such as a separation configuration, the printing substrate thickness, the printing substrate format, the grammage, an ink surface coverage, etc., in particular from the prepress run or from an upstream management information system (MIS) or Production Planning System (PPS), the paper white of the printing substrate being used, which is not supplied via the order preparation in the MIS or PPS, may be required, e.g. for presetting the measuring equipment. Particularly preferably, the mobile control unit is used for detecting the paper white of printing substrates. In particular, a measuring device based on spectrophotometry and/or a paper moisture meter can be integrated into the mobile control unit, in particular a tablet or preferably a smartphone. This allows an operator or user to detect the paper white optically in a simple manner, without the potential for input errors by the user. Alternatively, the mobile control unit can be connected, for example directly via USB or Bluetooth, to a spectrophotometric measuring device, for example a measuring head of a measuring table, and/or to a moisture meter. The mobile control unit may also be equipped for this purpose with a camera, an NFC sensor, a USB interface, and/or a Bluetooth interface. The operator or user (warehouse employee) can also use a commercially available hand-held spectrometer, in which case, once the spectrometer has detected a batch code, for example, the operator or user preferably enters the L*a*b* values in a corresponding input form in an app installed on the mobile control unit. Advantageously, such a hand-held spectrometer is always available in a processing machine system, in particular in a press room, since a hand-held spectrometer is part of the basic equipment included in every print shop.

During a printing substrate change, for example, in particular for a job change, the operator measures the paper white of the new printing substrate using the spectrophotometric measuring device. In conjunction with the mobile control unit, the values of the spectrophotometric measurement are supplied to a data management system, or stored values are edited, for example updated or supplemented. The data management system can be connected to a materials warehousing system, in particular a separate materials warehouse or at least one storage location or a temporary storage area, by which at least one consumable material, in particular the printing substrate, for at least one processing machine is held in reserve. The data management system contains, in particular, the data of the materials inventory, which include the values of a spectrophotometric measurement assigned in particular to the printing substrate. The data management system can also be linked to one or more processing machines and/or to one or more post-press processing machines. A respective processing machine or post-press processing machine can thereby access the values stored in the data management system, for example, for setup processes. The processing machine, in particular the printing press, is therefore preferably connected to the data management system, in particular to a production planning system (PPS), referred to, for example, as Logotronic or Logotronic Professional, or is linked to a PPS. This enables, in particular, a receipt of goods, for example printing substrates, to be detected and/or batch tracking to be carried out using an app located on the mobile control unit, in conjunction with the production planning system (PPS).

More particularly, the values relating to the spectrophotometric measurement of printing substrates can be used for a job change on a printing press. This enables, in particular, a presetting of color control, which enables an uninterrupted job change, since it allows e.g. an inline color control system to be adjusted and/or calibrated to the new printing substrate. Preferably, an uninterrupted or fully automatic job change can thereby be carried out by the measuring equipment of the machine, in particular the printing press or sheet-fed printing press, which is calibrated on a job-specific basis. The fully automatic job change can be carried out without interruption because the color control system is instructed or calibrated in particular in advance regarding the paper white of the printing substrate to be used. The number of wasted sheets necessary to achieve a stable print image is advantageously reduced as a result.

### BRIEF DESCRIPTION OF THE DRAWING

In the following, the invention will be explained in detail by way of example. The accompanying drawing depicts schematically:

FIG. 1: a database table for a data management system of a processing machine system.

### DESCRIPTION OF THE PREFERRED EMBODIMENT

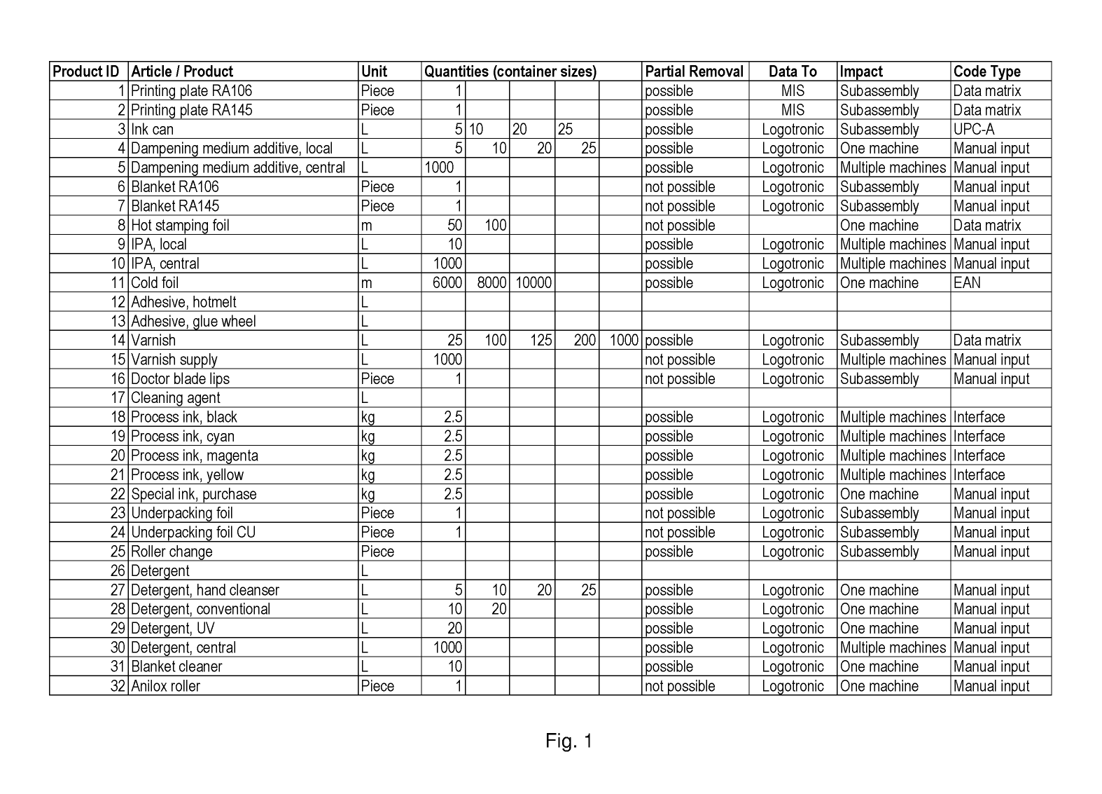

The sole FIG. 1 shows, for example, data for a data management system of a processing machine system in tabular form. The data of the data management system may include, in a first column, the product ID's not recorded here, which are stored, for example, in a material-specific feature of the processing machine system. The respective associated consumable materials or the product ID's thereof can be stored in particular in the location-specific features, in particular in tags or NFC tags. In a second column of the data management system data, the associated articles/products can be uniquely assigned to the product ID's. Here, the consumable material may involve substances to be replenished, such as cleaners or other liquids, or even materials to be replaced, such as doctor blade lips or rollers, in particular anilox rollers. The articles/products are, in particular, consumable materials for the processing machine system, in this case, in particular, consumable materials from the group composed of printing plates for one or more optionally different printing presses, in particular sheet-fed printing presses, of the processing machine system, ink can or ink cans, localized dampening medium additives, centralized dampening medium additives, blankets for the machine or for the various machines, hot stamping foil, IPA (isopropyl alcohol), cold foil, hot melt adhesive, glue wheel adhesive, varnish, varnish supply, doctor blade lips, cleaning agents, black, cyan, magenta and yellow process inks, special inks, underpacking foil, CU (coating unit) underpacking foil, roller changes, detergent, hand cleansers, conventional detergent, UV (ultraviolet) detergent, central detergent, blanket cleaners and anilox rollers for one or more machines. The data relating to the consumable material stored in the database may be stored on the basis of the machine, for example. Here, the consumable material may be stored in files specifically for different printing presses or groups of printing presses. For example, data for printing plates and blankets for a Rapida 106 and for a Rapida 145 may be stored in the database.

For each article/product, a unit can be stored in a third column and the quantity (container size) can be stored in a fourth column. The specified quantities may also be indicated or preselectable in defined sub-quantities. Whether or not a partial removal of the corresponding article/product is possible is stored in a fifth column. The associated control system to which the data or the modified data of the data management system are supplied or transmitted is stored in a sixth column. In this case, the additional systems are machine control systems or quality control systems, for example. In a seventh column, the impact of each article/product is stored. For example, an article/product may have an impact on an assembly or on one or more machines. In an eighth column, the way in which data can be captured for the respective article/product is recorded. Data may be captured, for example, by means of a data matrix code, barcodes (Universal Product Code UPC or European Article Number EAN), or manual input, in particular via the mobile control unit. Additional consumable materials may also be included and/or additional data relating to consumable materials may be recorded. The data recorded in the data management system can be transmitted to the mobile control unit as needed or upon request by the mobile control unit, so that the mobile control unit can make these data partially or fully available to the operator. Preferably, only those relevant data that are required at the location of the control unit or additional information linked to said data are transmitted.

For example, on a processing machine in the processing machine system, in particular a sheet processing machine, for example a sheet-fed printing press, specifically a sheet-fed offset rotary printing press in a unit and inline configuration, an order may be processed in which ink that can be replenished from an ink can is used as the consumable material. The ink is replenished by an operator at regular intervals or as needed. To replenish the ink, the operator proceeds with the mobile control unit to the specific location where the ink needs to be replenished. At said location, the operator can cause his mobile control unit to interact with the material-specific feature attached at that location, in particular with a tag or NFC tag. Via a specific NFC tag, for example, a unique identification code is recognized by the mobile control unit by means of NFC technology or data transmission, and the associated information is thereby made available, for example in conjunction with the data management system, on the mobile control unit. For example, if the ink will be replenished, additional information about that ink may be displayed to the operator, such as how many more kg will be needed for the current job and/or how many kg of that ink are still in stock and/or how much the ink supplied for the job costs and/or when the ink will next need to be replenished or reordered.

Information for a material change, for example a change of an anilox roller, can be supplied to the operator practically and easily, in a similar manner. For example, following the recognition of a suitably placed material-specific feature, such as a tag or NFC tag, by the mobile control unit, information such as the number of sheets that have been produced with the anilox roller and/or the theoretical lifespan of the anilox roller or how much longer the anilox roller can continue to be used can be displayed on the mobile control unit by way of the link to the data management system. A material-specific feature, in particular a tag or NFC tag, can be placed on the surface of the machine, for example, or on the inner side of a foldable protective cover, for example, in which case the protective cover must first be opened before the mobile control unit can be made to interact with the material-specific feature, in particular the tag or NFC tag. A preferred tag or NFC tag is preferably an object or element on the surface, which transmits information to the mobile control unit by electromagnetic means, in particular after being addressed electromagnetically by the mobile control unit.

It can further be provided to attach material-specific features, in particular tags or NFC tags, for additional products to a machine, a post-press processing machine, and/or consumable materials themselves. This is intended to enable one or more or all of the products from the group of consumable materials to be detected, in particular: printing plates, ink cans, dampening medium additives, blankets, hot stamping foil, hand cleansers, IPA, cold foil, hotmelt adhesive, glue wheel adhesive, varnish, doctor blade lips, cleaning agents, process inks, underpacking foil, CU underpacking foil, roller changes, UV detergent and/or blanket cleaners. For each material-specific feature provided, in particular each tag or NFC tag, which is recorded in the data management system, the link to the corresponding product can be established, wherein the data management system is preferably aware of the location of the relevant material-specific feature. It is also possible for multiple material-specific features, in particular tags or NFC tags, to be provided for one product. The data associated with the respective product are recorded by means of databases or by means of data management of the data management system. Upon transmission of an identification code or upon transmission of a code that is recognized by the mobile control unit, the data management system supplies the data to the mobile control unit for retrieval or for display. Via the mobile control unit, the relevant data are then made available to the operator by the mobile control unit. Changes to the data by means of the mobile control unit are also foreseen, if applicable according to release criteria and updates in the data management system.

It can further be provided for data relating to a control operation, for example an intended sheet removal in a delivery of a sheet processing machine, in particular a sheet-fed printing press, specifically a sheet-fed offset rotary printing press in a unit and inline configuration, as described above, to be supplied to the operator via the mobile control unit, in particular via a smartphone. In that case, an imminent, in particular automatically triggered test sheet removal and/or a request for the removal of waste paper sheets or defective sheets can be communicated to the operator. In particular, automatically generated test sheets or defective sheets that are detected by a quality control device, such as an inline inspection system, are provided for unanticipated sheet removal. The control operation, in particular the sheet removal, can be communicated in a timely manner, enabling the operator to move to the location of the control operation, in particular the sheet removal. The control operation can be communicated via the mobile control unit, in particular the smartphone, optically, acoustically, and/or mechanically, for example via a vibration alarm, if necessary along with additional information.

A warehouse management workflow and/or batch tracking workflow, for example, can also be implemented by means of an app installed on the mobile control unit, as described in the following by way of example in reference to the printing substrate. First, for example, the piles of printing substrate are received in particular at the warehouse entrance, for example, of the print shop. At the appropriate storage space provided for this purpose, or on a pallet, a tag or NFC tag assigned specifically to this printing substrate is attached. This NFC tag is scanned in, in particular by means of the NFC interface of the mobile control unit, in particular the smartphone, and by means of the app installed on said mobile control unit, and the quantity of printing substrate stored in the storage space marked by the NFC tag is entered into the warehouse management system of the data management system, in particular into the data of the materials inventory. In addition, a batch code indicating the quantity in stock is preferably already scanned in or recorded here.

A spectrometer coupled to the mobile control unit, for example, or a sensor or spectrometer for implementing a spectrophotometric measurement, integrated into the mobile control unit, enables the paper white of the printing substrate, for example the front and back sides thereof, to be recorded and assigned to the corresponding batch code at the time the goods are received or during the storage process, even before the printing substrate is placed in the materials warehouse. The paper white is measured by the sensor, for example, and is assigned to the batch within the data management system, in particular in the data of the materials inventory. A suitable near-infrared spectroscopic sensor SciO which can be coupled via Bluetooth 4.0 LE is available from Consumer Physics, for example. Also known, for example, is an app developed by the Fraunhofer Institute for spectrometric analysis, for which no additional hardware is required (HawkSpex® mobile), and which can be used in conjunction with sensors already integrated into mobile control units for the spectrophotometric measurement of inks.

Further preferably, a tag or NFC tag for consumable substances or materials, in particular the printing substrate, is attached to the machine, for example the sheet-fed printing press, as the consumption point. When a pile of printing substrate will be moved from the stock stored in this manner in the materials warehouse, for example, into a feeder of the sheet-fed printing press, the tag or NFC tag is scanned in by the mobile control unit, and thus the app installed on the mobile control unit logs the quantity to be consumed out of the inventory of the data management system, in particular the data of the materials inventory, for example, of the Logotronic. For the purpose of batch tracking, the operator or user is preferably requested by the app installed on the mobile control unit to record a batch code by means of the barcode/data matrix scanning module or camera or by manual input. This batch identifier is assigned in the data management system to the job located, for example, in the machine, in particular the sheet-fed printing press.

When, during a pile change, the batch code is then scanned in via the mobile control unit in conjunction with the installed app, the data management system, with the help of the mobile control unit, in particular using the data of the materials inventory, for example the Logotronic, can assign the paper white of the front and/or back sides to the job to be loaded or already located in the machines, and can thus make the paper white available to the measuring equipment. In particular, an inline measuring system, for example a quality control camera or an inspection system of the machine, can be calibrated in advance, for example, with the available data or values of the paper white measurement. With this step, during a job change, for example, a manual paper white measuring procedure is therefore no longer necessary, and a fully automatic job change can be carried out without interruption, i.e. without a manual measuring procedure, for example on the measuring table.

Furthermore, the mobile control unit can be expanded to include additional sensors and/or interfaces, so that additional parameters relevant to printing technology that can be used for automatic machine presetting, for example, can be detected already at a warehouse entrance. The mobile control unit thus enables the general detection of printing-relevant parameters of printing input materials, such as inks and printing substrates, or paper moisture measurements, for example in the pile, etc. and the automatic assignment of these parameters to a job to be loaded in a processing machine, in particular a printing press or sheet-fed printing press and/or a post-press processing machine, in particular for a preferably fully automatic machine presetting.

In a further preferred embodiment, the processes for producing a product, in particular in an operation involving multiple machines, are optimized. The processing machine system may include at least two production machines, e.g. a printing press and a punch, for example. For producing the product, a production control system PCS is included, in particular, which contains the job data (e.g. job number, job name, quantities, customer, delivery dates . . . ). The data link to the machine, for example the printing press and/or the punch, is produced with the aid of the at least one mobile control unit, with applications or programs being controlled on the mobile control unit in conjunction with support provided by tags or NFC tags.

Processing papers (e.g. labels, pile dockets) for each production lot are generated, for example, when a pile of printed sheets is removed from a sheet delivery of a sheet-fed printing press. The printing of a processing paper, for example the printing of a pile docket, is requested via the mobile control unit. With a tag or NFC tag, for example, which is preferably attached at a point on the machine for printing substrate removal, e.g. at the sheet delivery, a program is launched in the mobile control unit, in particular the smartphone, which establishes the link to the control system, in particular the PCS, MIS or data management system, and triggers the printing of a processing paper, e.g. the pile docket.

All relevant data that identify the lot or the pile, preferably along with a machine-readable code with which the lot or the pile can be clearly identified, are then printed on the processing paper (e.g. the pile docket). As an alternative to the code, the lot or the pile could also be assigned an additional tag or NFC tag with which an identification can be made. In that case, the physical printing of the processing papers (e.g. the pile dockets) could be dispensed with.

When the production lot or the pile arrives at the next machine, for example, likewise a printing press or a post-press processing machine, such as the punch, then a location-specific or machine-specific tag or NFC tag attached to the machine, in particular at a location for the infeed of a printing substrate, e.g. at the feed unit for the punch, launches at least one application (program) on the mobile control unit in particular fully automatically, for example solely as a result of proximity. The location, e.g. the location of the feed unit of the punch, is optionally automatically known to the application (app) or the program, so that said location can be connected, i.e. linked, to the data of the production lot or the pile. The production lot or the pile can be determined, for example, by scanning the code or identifying the tag or NFC tag. This leads, in particular, to the position of the production lot or the pile (optionally with the location or the time) being known or updated in the PCS or the MIS or the data management system. This information therefore enables the progress of the production run to be detected. For example, a job change may be displayed on the production machine, because the lot or the pile belongs to a new job, and so on.

An NFC tag can be detected particularly easily, without any further control operations, simply by the mobile control unit moving closer to the specific NFC tag, with the NFC tag being detected by the mobile control unit, in particular, at a distance between the NFC tag and the mobile control unit of less than 4 cm. Contact between the mobile control unit and the NFC tag is not required.

While a preferred embodiment of a processing machine system and a method for operating a processing machine system, in accordance with the present invention, has been set forth fully and completely hereinabove, it will be apparent to one of skill in the art that various changes could be made without departing from the true spirit and scope of the subject invention, which is accordingly to be limited only by the appended claims.

1-50. (canceled)

51. A processing machine system having at least one mobile control unit, wherein at least one material-specific feature of the processing machine system can be detected by the mobile control unit, wherein, upon detection of the material-specific feature by the mobile control unit, data associated with the feature can be and/or are supplied to an operator by the mobile control unit, and wherein the data associated with the feature contain data relating to at least one consumable material of the processing machine system, characterized in that the material-specific feature is a tag which can be detected by the mobile control unit in a contactless manner, without a control operation, solely as a result of proximity, at a distance of less than 4 cm between the mobile control unit and the tag.

52. The processing machine system according to claim 51, characterized in that multiple tags are provided in the processing machine system, on a processing machine, and/or on a post-press processing machine, wherein each tag has or contains in particular a unique identification code.

53. The processing machine system according to claim 51, characterized in that the tag includes or contains at least one link to an application of a data management system and/or a machine controller, which application is to be loaded specifically onto the mobile control unit.

54. The processing machine system according to claim 51, characterized in that the tag contains connection information for the mobile control unit, which links the mobile control unit to data or specific data of a data management system, a production control system, and/or a machine controller.

55. The processing machine system according to claim 51, characterized in that the consumable material is a printing substrate that is or will be imprinted, or the consumable material is selected from a group composed of printing plate, ink can, dampening medium additive, blanket, hot stamping foil, hand cleanser, IPA, cold foil, hotmelt adhesive, glue wheel adhesive, varnish, doctor blade lip, cleaning agent, process ink, underpacking foil, CU underpacking foil, roller, UV detergent and/or blanket cleaner.

56. The processing machine system according to claim 51, characterized in that the data of the consumable material include a job number, a job name, a quantity, customer data, and/or a delivery date, or the data of the consumable material comprise the designation, the quantity, the unit, the price, a partial removal option, information about data transfers, the scope of influence, and/or data entry or modification options.

57. The processing machine system according to claim 51, characterized in that the mobile control unit is linked to a data management system which is linked to a materials warehousing system, wherein the data management system contains data relating to the materials inventory of consumable materials.

58. A method for operating a processing machine system having at least one mobile control unit, wherein at least one material-specific feature of the processing machine system is detected by the mobile control unit, and
wherein, upon detection of the material-specific feature by the mobile control unit, data associated with the feature are supplied to an operator by the mobile control unit, and wherein the data associated with the feature contain data relating to at least one consumable material of the processing machine system, characterized in that the material-specific feature is a tag which is recognized with the aid of the mobile control unit, and in that a sensor system of the mobile control unit is activated automatically upon or as a result of detection of the tag by the mobile control unit.

59. The method according to claim 58, characterized in that with the aid of the mobile control unit, the tag is recognized without any control operation, simply by the mobile control unit moving closer to the specific tag, and/or in that upon recognition of a detected tag, the mobile control unit is provided with and/or receives the feature-dependent data from a data management system without additional control operation.

60. The method according to claim 58, characterized in that data relating to consumable materials are received and/or are transmitted to a data management system by means of a sensor system of the mobile control unit, and/or in that the data relating to the consumable material are supplied dependent upon the particular recognized tag.

61. The method according to claim 58, characterized in that data relating to control operations to be carried out on a processing machine and/or a post-press processing machine in the processing machine system are supplied to the operator by the mobile control unit, and/or in that the operator is guided and/or directed through individual steps of control operations by the mobile control unit.

62. The method according to claim 58, characterized in that after a particular tag embodied as an NFC tag is addressed electromagnetically via an NFC interface of the mobile control unit, data relating to consumable material, which are assigned via the particular NFC tag or are stored on the NFC tag, can be supplied to the mobile control unit via the particular NFC tag.

63. The method according to claim 58, characterized in that the mobile control unit communicates wirelessly and/or via a web server, and/or in that a plurality of mobile control units are linked to a data management system, in particular a production control system, of the processing machine system.

64. The method according to claim 58, characterized in that information regarding quantities of consumable materials that are in stock for a current print job on a printing press is supplied via the mobile control unit, and/or in that information regarding job-specific quantities of required consumable materials is supplied via the mobile control unit.

65. A use of a mobile control unit of a processing machine and/or a post-press processing machine of a processing machine system for the purpose of supplying data relating to at least one consumable material of the processing machine system following a specific recognition of a detected tag or NFC tag.
